(19) United States
(12) Patent Application Publication
(10) Pub. No.: US 2025/0363372 A1
(43) Pub. Date: Nov. 27, 2025

(54) Generative Artificial Intelligence to Create Customized Responses Based on User Contextual Data and Analytics

(71) Applicant: Dell Products L.P., Round Rock, TX (US)

(72) Inventors: Fatemeh Azmandian, Raynham, MA (US); Michael Barnes, Doylestown, PA (US); Edward Henry, Jurupa Valley, CA (US); Sivakumar Kondaraju, Cary, NC (US); Ashutosh P. Nanekar, Cary, NC (US); Corinne Schulze, Hopkinton, MA (US)

(21) Appl. No.: 18/673,238

(22) Filed: May 23, 2024

(51) Int. Cl. G06N 3/0895; G06N 5/022

(52) U.S. Cl. CPC G06N 3/0895; G06N 5/022

(57) ABSTRACT

A system can receive user input data that comprises an identification of a computer infrastructure component of a group of computer infrastructure components that are associated with a user account. The system can identify information about the group of computer infrastructure components based on the identification of the computer infrastructure component. The system can convert text of the user input data into a first numerical vector. The system can create a context of the user input data based on identifying a match between the first numerical vector and a second numerical vector of a group of numerical vectors, wherein the context corresponds to a natural-language version of the second numerical vector. The system can combine the context and the information about the group of computer infrastructure components into a combined context, and input the combined context and the user input data to a large language model to produce a result.

### BACKGROUND

General artificial intelligence (AI) generally comprises technology that is configured to generate an output (e.g., text or an image) from an input prompt, and based on a generative model.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive user input data that comprises an identification of a computer infrastructure component of a group of computer infrastructure components that are associated with a user account. The system can identify information about the group of computer infrastructure components based on the identification of the computer infrastructure component. The system can convert text of the user input data into a first numerical vector. The system can create a context of the user input data based on identifying a match between the first numerical vector and a second numerical vector of a group of numerical vectors, wherein the context corresponds to a natural-language version of the second numerical vector. The system can combine the context and the information about the group of computer infrastructure components into a combined context. The system can input the combined context and the user input data to a large language model to produce a result. The system can make the result accessible via the user account.

An example method can comprise receiving, by a system comprising at least one processor, user input data that comprises an identification of computer infrastructure that is associated with a user account. The method can further comprise identifying, by the system, information about the computer infrastructure based on the identification of the computer infrastructure. The method can further comprise converting, by the system, text of the user input data into a first numerical vector. The method can further comprise creating, by the system, a context of the user input data based on identifying a match between the first numerical vector and a second numerical vector, wherein the context corresponds to a natural-language version of the second numerical vector. The method can further comprise combining, by the system, the context and the information about the computer infrastructure into a combined context. The method can further comprise sending, by the system, the combined context and the user input data to a large language model to produce a result. The method can further comprise making, by the system, the result accessible to the user account.

An example non-transitory computer-readable medium can comprise instructions that, in response to execution, cause a system comprising a processor to perform operations. These operations can comprise receiving data that comprises an identification of a computer infrastructure that is associated with a user account. These operations can further comprise identifying information about the computer infrastructure. These operations can further comprise converting text of the data into a first numerical vector. These operations can further comprise creating a context of the data based on identifying a similarity between the first numerical vector and a second numerical vector. These operations can further comprise combining the context and the information about the computer infrastructure into a combined context. These operations can further comprise sending the combined context and the data to an artificial intelligence or machine learning model to produce a result. These operations can further comprise enabling the result to be accessed via the user account.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate using generative AI to create customized responses based on user contextual data and analytics, in accordance with an embodiment of this disclosure;

FIG. 2 illustrates another example system architecture that can facilitate using generative AI to create customized responses based on user contextual data and analytics, in accordance with an embodiment of this disclosure;

FIG. 3 illustrates another example system architecture that can facilitate using generative AI to create customized responses based on user contextual data and analytics, in accordance with an embodiment of this disclosure;

FIG. 4 illustrates an example process flow that can facilitate using generative AI to create customized responses based on user contextual data and analytics, in accordance with an embodiment of this disclosure;

FIG. 5 illustrates another example process flow that can facilitate using generative AI to create customized responses based on user contextual data and analytics, in accordance with an embodiment of this disclosure;

FIG. 6 illustrates another example process flow that can facilitate using generative AI to create customized responses based on user contextual data and analytics, in accordance with an embodiment of this disclosure;

FIG. 7 illustrates another example process flow that can facilitate using generative AI to create customized responses based on user contextual data and analytics, in accordance with an embodiment of this disclosure;

FIG. 8 illustrates another example process flow that can facilitate using generative AI to create customized responses based on user contextual data and analytics, in accordance with an embodiment of this disclosure;

FIG. 9 illustrates another example process flow that can facilitate using generative AI to create customized responses based on user contextual data and analytics, in accordance with an embodiment of this disclosure;

FIG. 10 illustrates another example process flow that can facilitate using generative AI to create customized responses based on user contextual data and analytics, in accordance with an embodiment of this disclosure;

FIG. 11 illustrates an example block diagram of a computer operable to execute an embodiment of this disclosure.

### DETAILED DESCRIPTION

### Overview

The present techniques can be implemented to facilitate a user querying a generative artificial intelligence (AI) system. Such a generative AI system can comprise a retrieval augmented generation (RAG) system, a large language model (LLM), data sources (which can include data streams and databases that store user contextual information), and analytic features and/or methods that can act on those data sources.

A RAG system can generally access a specific knowledge base and use this information as input to a LLM to optimize a LLM's answer. A LLM can comprise a form of generative AI.

Specific natural language processing (NLP) techniques and query techniques can be applied to data sources and analytics features/methods to provide queries to a RAG that is connected to an enterprise knowledge base. Another technique can involve combining information retrieved from a RAG and user contextual data sources, and analytics features/methods as enhanced context to a LLM in order to create highly-customized responses to user queries.

NLP techniques generally involve computer manipulation of the human language (e.g., text in the English language).

For users of a cloud platform that provides analytics information about the users' hardware (which can be on premises and/or hosted), the present techniques can be implemented to facilitate those users receiving personalized responses to queries about the infrastructure they have. These customized responses can be generated through an application of data sources of the cloud platform (e.g., health score, anomaly detection, noisy neighbor, resources in contention), as well as install base data, which can provide a location of an environment that the user is managing and its related support information.

It can be that prior approaches to generative AI tools such as RAG systems with LLMs can only provide responses to queries with accessible data. When the accessible data is an enterprise knowledge base that comprises knowledge base articles (KBAs), manuals, release notes, etc., the generated answers can lack a sense of personalization or customization to the user and/or customer-specific working infrastructure and ISG products. According to prior approaches, a typical RAG system with an LLM lacks a capability for customization or personalization.

According to the present techniques, a more sophisticated and highly augmented generative AI system can be implemented that can query user contextual data sources and analytics to provide highly customized and personalized responses, including detailed answers incorporating user contextual data combined with solutions from an enterprise knowledge base. For examples, users of a cloud platform could ask about the state or status of a specific product in their infrastructure. A personalized response would incorporate specific system metric, config and health check data combined with context from an enterprise knowledge base that provides recommendations for continued healthy operation or remediation to identified problems.

That is, the present techniques can combine two contexts in answering user questions. One context can relate to the user's environment, and include information about the user's computer system and telemetry about the computer system. Another context can be from a RAG, and relate to knowledge base articles that describe system problems across multiple users. It can be that the LLM has not been trained on this knowledge base article corpus, so the RAG system can supplement the LLM's abilities.

These contexts can be combined and provided to a LLM along with the user's question. For instance, the context can be, “answer the user's question using the info in the following knowledge base articles . . . ,” “If you do not know the answer, say you do not know,” “provide a link to the knowledge base article you used to answer the question,” or “prioritize the root cause analysis (RCA) output in your answer.” This can be in addition to the user's question itself, which can be, for example, “why is my storage system operating slowly?”

The present techniques can be implemented to facilitate a generative AI model that is be able to incorporate real time metrics, configuration, health checks, and cloud platform tooling in order to create highly personalized responses to user questions about their infrastructure.

Example use cases of the present techniques can include the following. A user can experience high latency for a volume on their data storage system. The user can ask the generative AI tool about why this may be happening. The tool can answer the question with information on another volume using too many resources, and provides a recommendation on how to reduce the resources use of the other volume based on other factors within their environment.

In another example, a user can receive an alert that a particular data storage system is over 70% threshold in capacity, but a monitoring application says that it is at 50%. The tool response can state, “This system has a data reduction ratio greater than 32:1, which is creating these alarms. Your replications sessions are set to X frequency and may be the cause of this highly compressible data.” The personalized response can ask the user, “Do you mean to do this?” and provide recommendations from an enterprise knowledge base to resolve the problem.

In another example, a user is interacting with a generative AI system according to the present techniques about basic input/output system (BIOS) update to a data storage system, and the generative AI system can bring context around a number of data storage systems in the user's environment that are currently experiencing this issue, as well as a recommendation on how to upgrade to a recommended version.

In another example, a user is notified of a data storage system issue about a cluster not configured for optimized performance, and the user asks the generative AI system about what this means. The tool can answer the question and bring an additional specific fix that was applied for a similar issue on another system using a support context and service ticket data.

The present techniques to augment a generative AI System that provides highly customized and personalized responses can be implemented in a cloud platform to provide users with real solutions to specific product issues. This can enable customers to directly resolve problems in an expedited manner and serve as a significant service cost reduction for incident detection and response, and/or managed detection and response events.

The present techniques can leverage analytics capabilities such as noisy neighbor and resources in contention analysis, which can provide custom root cause analysis for a user's specific system and can empower a LLM to quickly address user questions about issues that are facing, as well as suggest steps to remediate the problem.

The present techniques can facilitate a specialization of a LLM's response to provide user-specific recommendations instead of retrieval-augmented generic responses. As part of the answer returned from the LLM, references (such as KBAs) and analytics results can be returned that bolster the recommendations from the LLM.

For analytics, data sources can include metrics and configuration data from a database, alerts stored in a search server. Analytics sources can include sources that can be accessed from an analytics portal such as health score, performance anomaly detection, noisy neighbors, resources in contention, etc.

In a more general enterprise application, data sources can include various data stores (including data lakes and data lakehouses) and streaming telemetry. Analytics sources can include results from a statistical, machine or deep learning model, user install base, support and service ticket data, etc.

### Example Architectures

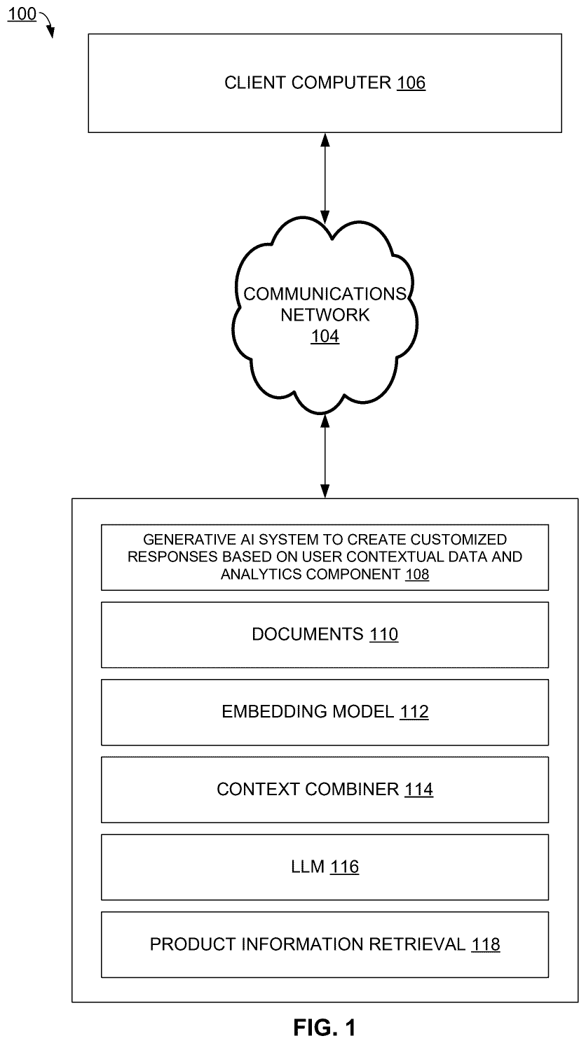

FIG. 1 illustrates an example system architecture 100 that can facilitate using generative AI to create customized responses based on user contextual data and analytics, in accordance with an embodiment of this disclosure.

System architecture 100 comprises server 102, communications network 104, and client computer 106. In turn, server 102 comprises generative AI system to create customized responses based on user contextual data and analytics component 108, documents 110, embedding model 112, context combiner 114, LLM 116, and product information retrieval 118.

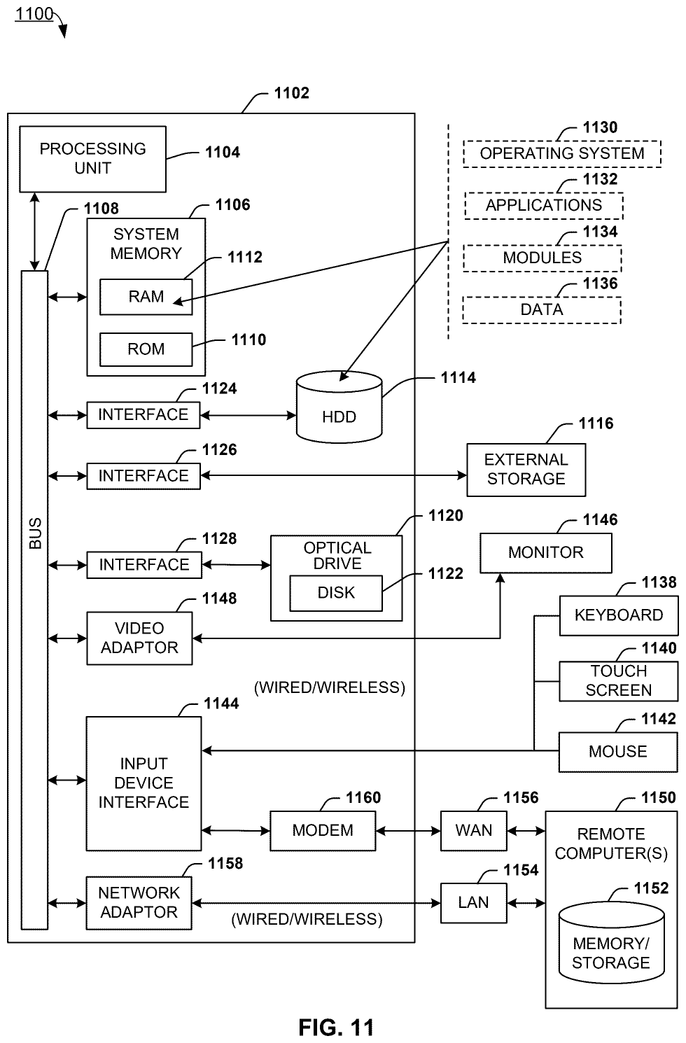

Each of server 102 and/or client computer 106 can be implemented with part(s) of computing environment 1100 of FIG. 11. Communications network 104 can comprise a computer communications network, such as the Internet.

In some examples, a user account associated with client computer 106 can send a question to server 102 via communications network 104, where the question relates to the user account's infrastructure. Generative AI system to create customized responses based on user contextual data and analytics component 108 can process this question and return answer to client computer 106 that is specific to the user account's infrastructure. In doing so, generative AI system to create customized responses based on user contextual data and analytics component 108 can retrieve information about the user account's products from product information retrieval 118, documents related to those products from documents 110, create an embedding for those documents and the user account's query with embedding model 112, combine the context into a personalized context with context combiner 114, and provide the combined context and the question to LLM 116. LLM 116 can produce an answer to the question (using the personalized information for the user account), and that answer can be returned to client computer 106.

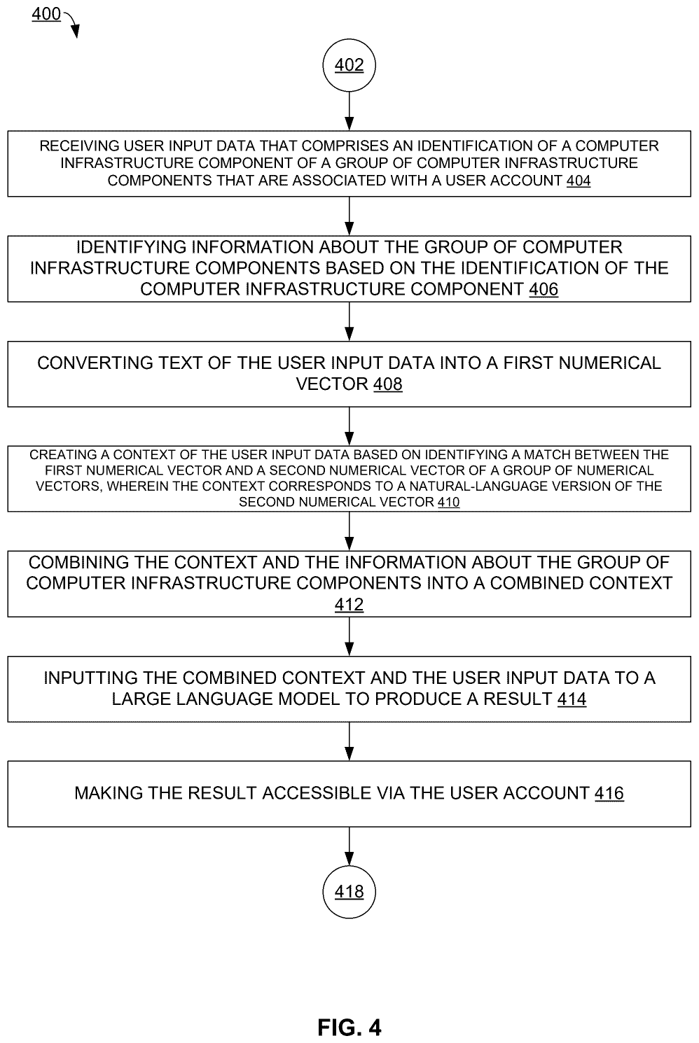

In some examples, generative AI to create customized responses based on user contextual data and analytics component 108 can implement part(s) of the process flows of FIGS. 4-10 to facilitate using generative AI to create customized responses based on user contextual data and analytics.

It can be appreciated that system architecture 100 is one example system architecture for proactive prevention of data unavailability and data loss, and that there can be other system architectures that facilitate using generative AI to create customized responses based on user contextual data and analytics.

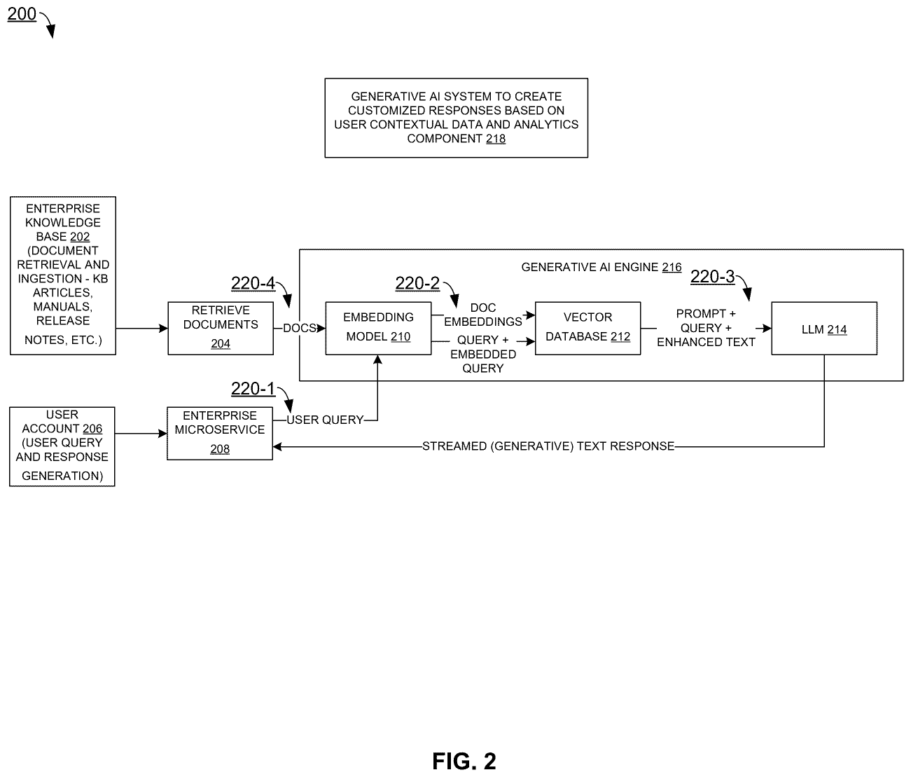

FIG. 2 illustrates another example system architecture 200 that can facilitate using generative AI to create customized responses based on user contextual data and analytics, in accordance with an embodiment of this disclosure. In some examples, part(s) of system architecture 200 can be implemented by system architecture 100 of FIG. 1 to facilitate using generative AI to create customized responses based on user contextual data and analytics.

System architecture 200 comprises enterprise knowledge base 202 (document retrieval and ingestion—KB articles, manuals, release notes, etc.), retrieve documents 204, user account 206 (user query and response generation), enterprise microservice 208, embedding model 210, vector database 212, LLM 214, generative AI engine 216, and generative AI system to create customized responses based on user contextual data and analytics component 218.

At 220-1, a user asks a LLM a question, another model converts the question text into a numeric format (which can be referred to as an embedding or a vector).

At 220-2, an embedding model can compare the numeric values to vectors in a vector database that is derived from an enterprise knowledge base (which can comprise KBAs, product articles, release notes, service requests, etc.).

At 220-3, the LLM can combine the retrieved words and its own response to the query into a final answer, and cite sources (e.g., KBAs) found by the embedding model.

At 220-4, the embedding model can continuously create and update a vector database from the enterprise knowledge base as new content becomes available.

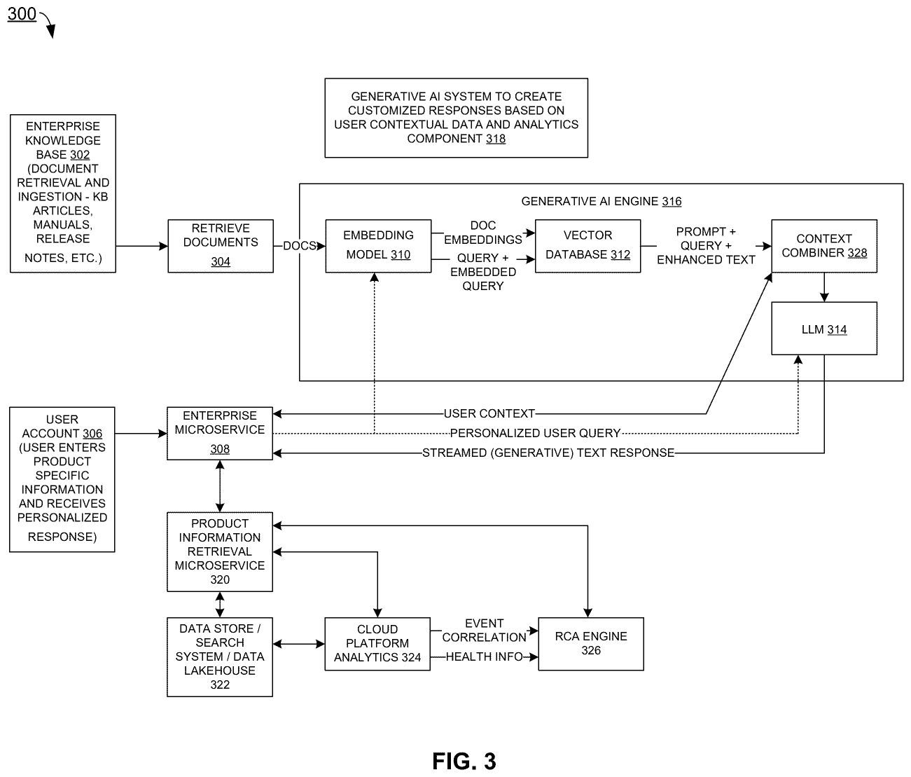

FIG. 3 illustrates another example system architecture 300 that can facilitate using generative AI to create customized responses based on user contextual data and analytics, in accordance with an embodiment of this disclosure. In some examples, part(s) of system architecture 300 can be implemented by system architecture 100 of FIG. 1 to facilitate using generative AI to create customized responses based on user contextual data and analytics.

System architecture 300 comprises enterprise knowledge base 302 (document retrieval and ingestion—KB articles, manuals, release notes, etc.), retrieve documents 304, user account 306 (user query and response generation), enterprise microservice 308, embedding model 310, vector database 312, LLM 314, generative AI engine 316, and generative AI system to create customized responses based on user contextual data and analytics component 318. These parts of system architecture 300 can be similar to enterprise knowledge base 202, retrieve documents 204, user account 206 (user query and response generation), enterprise microservice 208, embedding model 210, vector database 212, LLM 214, generative AI engine 216, and generative AI system to create customized responses based on user contextual data and analytics component 218 of FIG. 2, respectively.

System architecture 300 also comprises product information retrieval microservice 320, data store/search system/data lakehouse 322 (which can generally comprise a source of user system telemetry and insights), cloud platform analytics 324, root cause analysis (RCA) engine 326 (which can generally output a guess as to a root cause of a problem experienced by a user), and context combiner 328.

The present techniques can incorporate approaches to combine user-specific product information with documents retrieved by a RAG system from an enterprise knowledge base. An example of such a system is depicted in FIG. 3. When compared with FIG. 2, two additional microservices, a context combiner and a product information retrieval, are included in addition to data sources that provide specific information related to user-owned products. It can be appreciated that this example is an example, and that the present techniques can be applied to user-specific information (and metrics) that are related to other types of (enterprise) generative application, where responses are enhanced and augmented with personalized content.

Example implementations of the present techniques can include the following components:
A context combiner can combine text/references from the RAG system extracted from the enterprise knowledge base with user product specific information extracted from cloud platform data and analytic sources. The context combiner can generally incorporate personalized user information with context obtained from an enterprise knowledge base through retrieval augmented generation.
A product information retrieval microservice can retrieve user product-specific information from data and analytic sources. Data can be converted in a structured manner (such as to JavaScript Object Notation (JSON) format strings and sent to the context combiner. User product-specific configuration data, alerts and other service disruption events can be sent in formulated queries to the RAG system. Hence, context can be retrieved from the RAG system directly related to the user product and problems (if they exist).
The response from the LLM can include a state/status of a specific product under consideration combined with a recommendation and information that is relevant to remediation or continued healthy operation. An enterprise knowledge base reference—e.g., links to knowledge base (KB) articles—can be included with the response.

For a cloud platform, the data sources can include metrics and configuration data from a database (e.g., a NoSQL distributed database), and alerts stored in a search server. The analytics sources can include sources that can be accessed within a cloud platform portal, such as health score, performance anomaly detection, noisy neighbors, resources in contention, etc. In a more general enterprise application, data sources can include a variety of data stores (including data lakes and data lakehouses) and streaming telemetry. Analytics sources can include results from a statistical, machine or deep learning model, and a customer install base, and/or support and service ticket data.

For a context combiner, different techniques can be incorporated to combine the results, including reciprocal rank fusion and cross encoders. Another aspect of the context combiner can comprise parsing and inclusion of configuration information of a system. The “config” of a system can comprise a collection of files in different formats like JSON, comma-separated values (CSV), and text. It can come in different formats for different products. It can be that the distribution of term counts does not conform to a normal distribution or a Zipf distribution (relating to human language text frequencies). There can be system/part/network identifiers that are mostly a mix of alphanumeric characters and, are not generally used for matching with KB articles (KBAs). These can be removed using a regular expression (regex). There can be some terms that occur in very large counts compared to others, so a normalization, like a logarithmic normalization, can be used to reduce an undue impact of one term. In some examples, alerts and other texts can be used as-is, where their text distribution matches with that of a vocabulary of the LLM, and what the LLM has been trained on. Keywords can be extracted from a config file for a product. These can then be combined with the query that is provided to the embedding similarity search. Subsequently, this can also be combined with text sent to an LLM.

A use case/workflow as depicted in FIG. 3 can be as follows:
1. A user logs in and enters product-specific information—e.g., specific information that identifies the system, such as a service tag or a GDS identifier.
2. An enterprise microservice can query a product information retrieval microservice, which can then query cloud platform data stores, analytic models, and a root cause analysis engine.
3. In some examples, information can be returned to an enterprise microservice in two forms: (a) JSON strings from config, metrics, alerts, and service disruption data; and (b) a personalized user query, which can comprise a question-like text, or other text that can form the basis for a query derived from config, alert and service disruption data.
4. The personalized user query can be sent to an embedding model in the RAG system and also to the LLM.
5. A context generated from the RAG system and JSON context from the information retrieval service can be combined/prioritized in a context combiner.
6. The combined context can be fed to a LLM from the context combiner.
7. The LLM can provide a response to the personalized user query based on the combined context.
8. The user can ask follow-up questions, which can be combined with the personalized user query to create an augmented user query to gain a more detailed understanding of issues, recommendations, remediations, etc.

### Example Process Flows

FIG. 4 illustrates an example process flow 400 for using generative AI to create customized responses based on user contextual data and analytics, in accordance with an embodiment of this disclosure. In some examples, one or more embodiments of process flow 400 can be implemented by system architecture 100 of FIG. 1, or computing environment 1100 of FIG. 11.

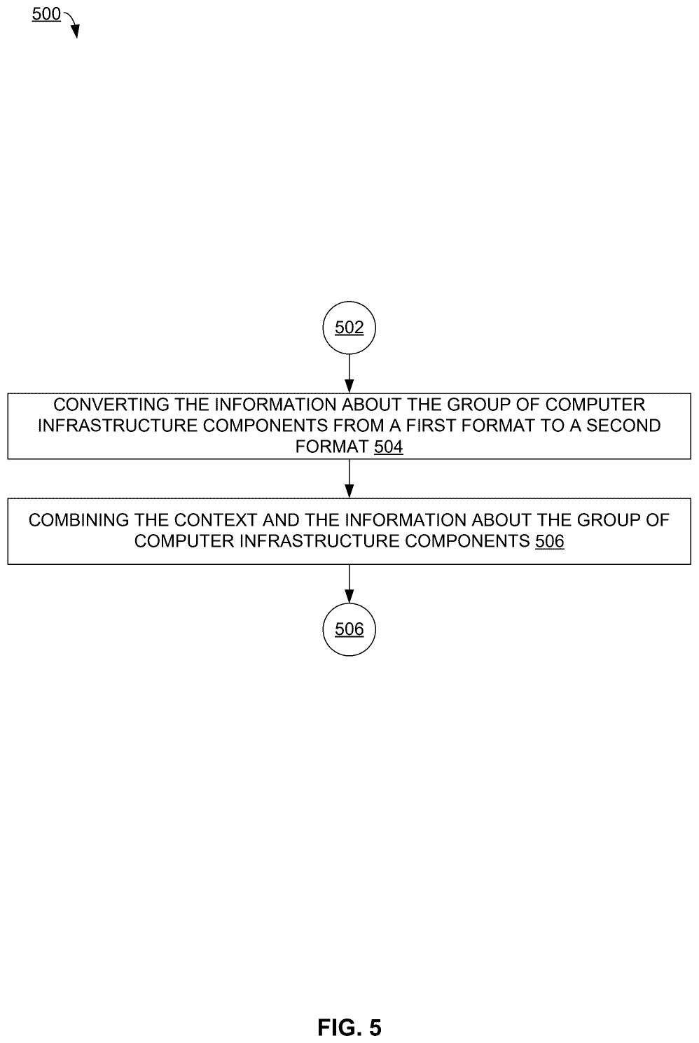

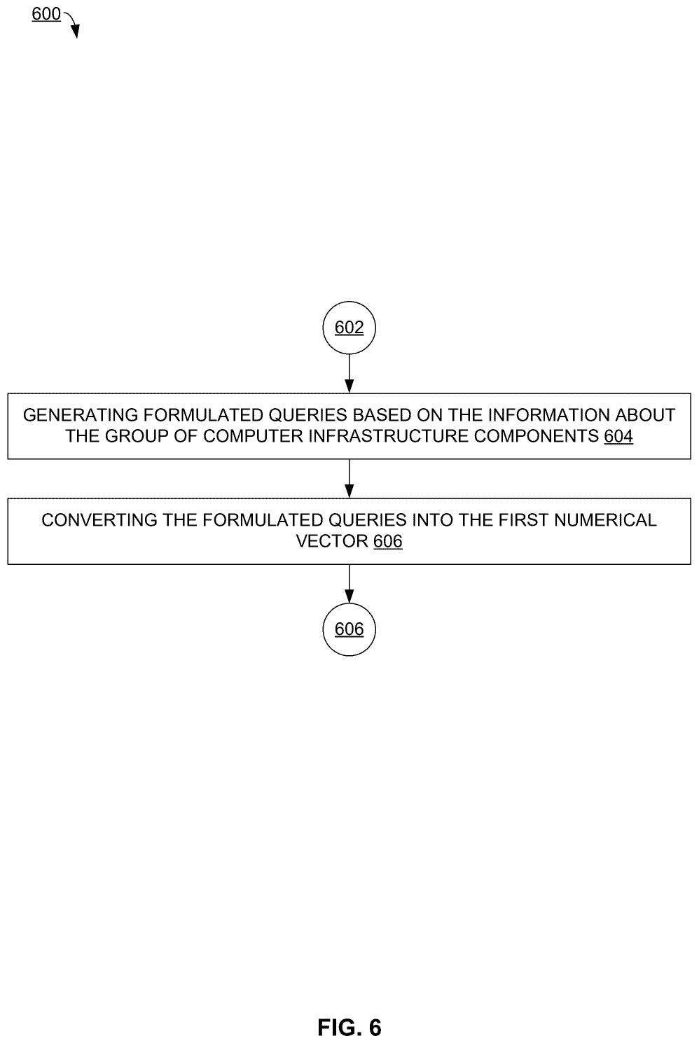

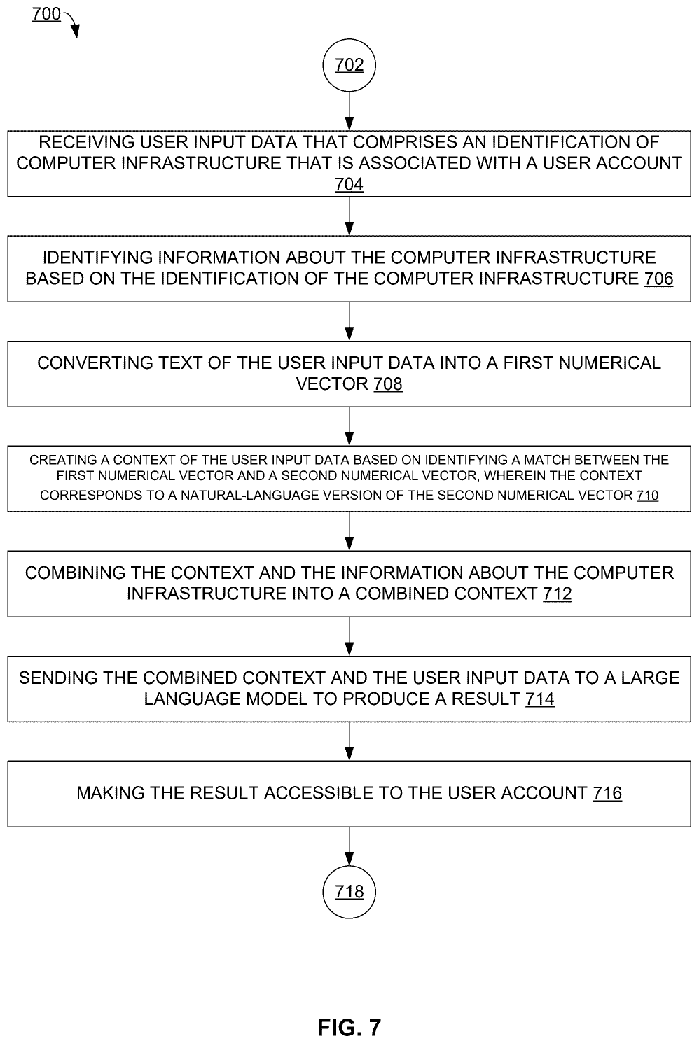

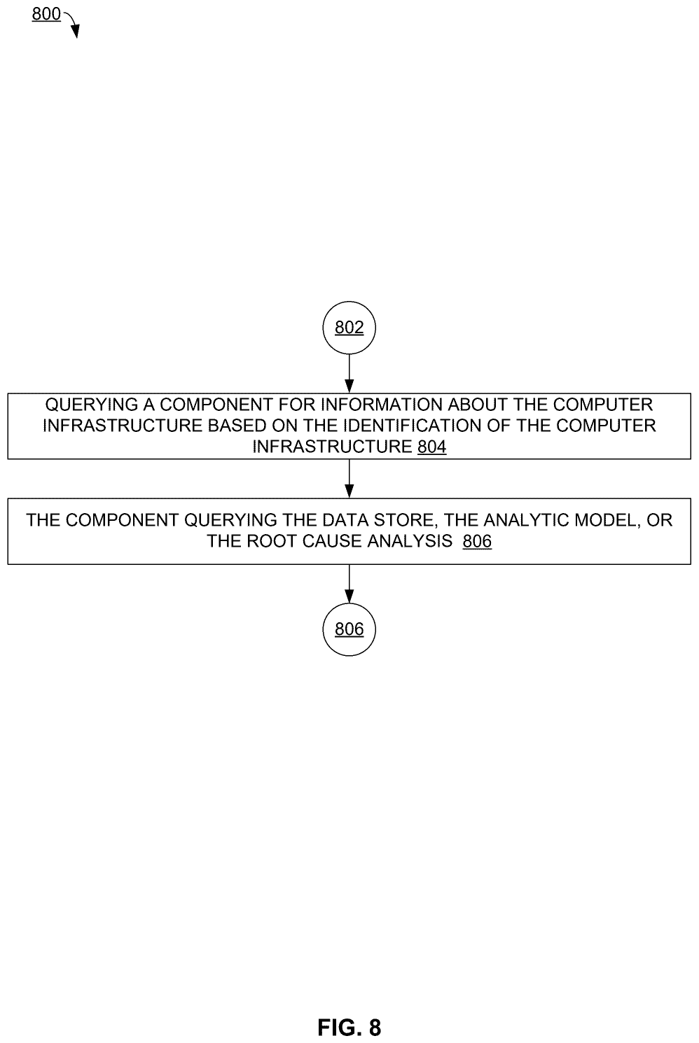

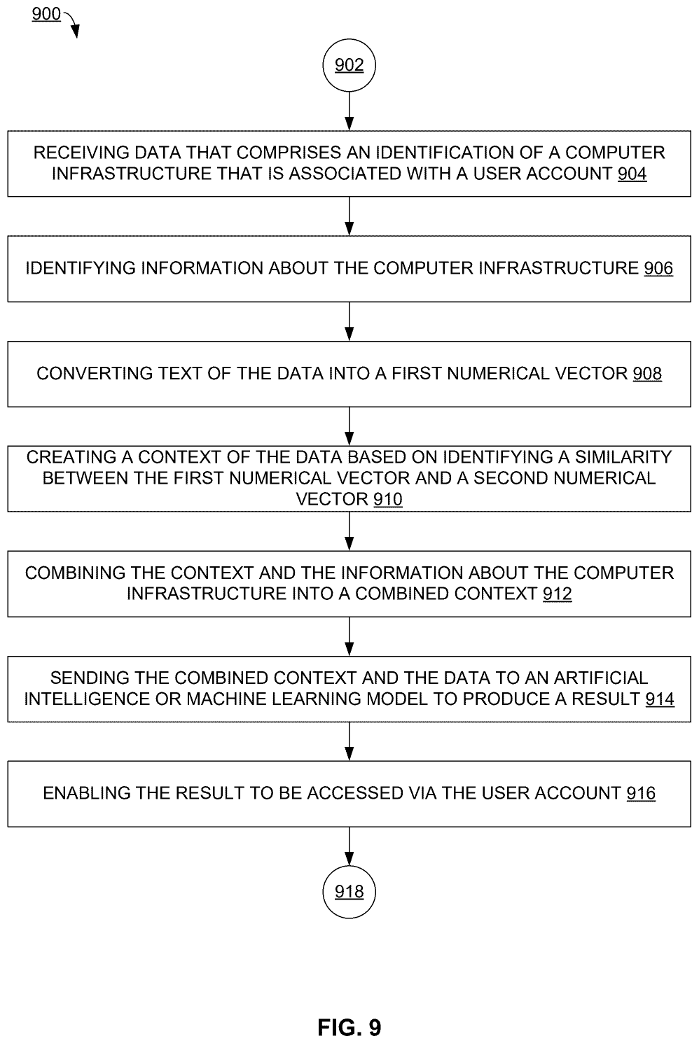

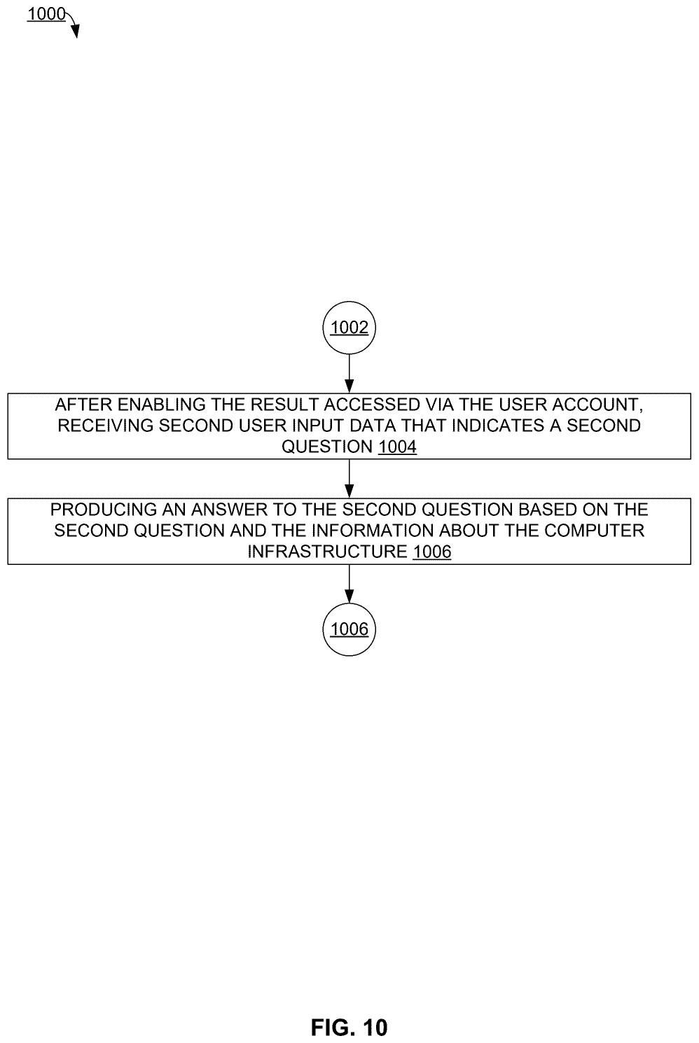

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 400 begins with 402, and moves to operation 404.

Operation 404 depicts receiving user input data that comprises an identification of a computer infrastructure component of a group of computer infrastructure components that are associated with a user account. That is, a user can ask a question about its infrastructure.

After operation 404, process flow 400 moves to operation 406.

Operation 406 depicts identifying information about the group of computer infrastructure components based on the identification of the computer infrastructure component. That is, information about the user's infrastructure status can be obtained.

After operation 406, process flow 400 moves to operation 408.

Operation 408 depicts converting text of the user input data into a first numerical vector. That is, an embedding of the user's question can be determined.

In some examples, converting the text of the user input data into the first numerical vector comprises converting the information about the group of computer infrastructure components into the first numerical vector. This can be performed in a similar manner as 220-1 of FIG. 2.

After operation 408, process flow 400 moves to operation 410.

Operation 410 depicts creating a context of the user input data based on identifying a match between the first numerical vector and a second numerical vector of a group of numerical vectors, wherein the context corresponds to a natural-language version of the second numerical vector. That is, an embedding model can be used to determine a context from the user's embedding.

After operation 410, process flow 400 moves to operation 412.

Operation 412 depicts combining the context and the information about the group of computer infrastructure components into a combined context. That is, a context combiner can be used to combine the context with the information about the user's infrastructure.

After operation 412, process flow 400 moves to operation 414.

Operation 414 depicts inputting the combined context and the user input data to a large language model to produce a result. That is, the combined context and the user's original question can be passed as input into an LLM.

In some examples, the result comprises information about a status of the computer infrastructure component, and a recommendation or information relevant to remediation of an issue with the computer infrastructure component or continued healthy operation of the computer infrastructure component. In some examples, the result comprises a link to a knowledge base article regarding the computer infrastructure component. That is, in some examples, users of a cloud platform could ask about the state or status of a specific product in their infrastructure. A personalized response would incorporate specific system metric, config and health check data combined with context from an enterprise knowledge base that provides recommendations for continued healthy operation or remediation to identified problems.

After operation 414, process flow 400 moves to operation 416.

Operation 416 depicts making the result accessible via the user account. That is, the LLM's output (of the input in operation 416) can be provided to the user.

After operation 416, process flow 400 moves to 418, where process flow 400 ends.

FIG. 5 illustrates an example process flow 500 for using generative AI to create customized responses based on user contextual data and analytics, in accordance with an embodiment of this disclosure. In some examples, one or more embodiments of process flow 500 can be implemented by system architecture 100 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 400 of FIG. 4, process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts converting the information about the group of computer infrastructure components from a first format to a second format. For example, the information can be converted from one format into JSON strings.

In some examples, the second format comprises a human-readable text format. This can be a JSON format.

After operation 504, process flow 500 moves to operation 506.

Operation 506 depicts combining the context and the information about the group of computer infrastructure components. That is, after the information is converted in operation 504, then it can be sent to a context combiner.

In some examples, operations 504-506 combine to comprise converting the information about the group of computer infrastructure components from a first format to a second format before combining the context and the information about the group of computer infrastructure components.

After operation 506, process flow 500 moves to 508, where process flow 500 ends.

FIG. 6 illustrates an example process flow 600 for using generative AI to create customized responses based on user contextual data and analytics, in accordance with an embodiment of this disclosure. In some examples, one or more embodiments of process flow 600 can be implemented by system architecture 100 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 400 of FIG. 4, process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

In some examples where process flow 600 is implemented in conjunction with process flow 400, process flow 600 can be implemented to facilitate converting of the information about the group of computer infrastructure components into the first numerical vector.

Operation 604 depicts generating formulated queries based on the information about the group of computer infrastructure components. In some examples, the formulated queries comprise user account-specific configuration data of the user account, an alert associated with the user account, or information about a service disruption event of the user account.

After operation 604, process flow 600 moves to operation 606.

Operation 606 depicts converting the formulated queries into the first numerical vector. That is, context can be retrieved from a RAG system and converted.

After operation 606, process flow 600 moves to 608, where process flow 600 ends.

FIG. 7 illustrates an example process flow 700 for using generative AI to create customized responses based on user contextual data and analytics, in accordance with an embodiment of this disclosure. In some examples, one or more embodiments of process flow 700 can be implemented by system architecture 100 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 400 of FIG. 4, process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts receiving user input data that comprises an identification of computer infrastructure that is associated with a user account. In some examples, operation 704 can be implemented in a similar manner as operation 404 of FIG. 4.

In some examples, the identification of the computer infrastructure comprises a service tag of the computer infrastructure.

After operation 704, process flow 700 moves to operation 706.

Operation 706 depicts identifying information about the computer infrastructure based on the identification of the computer infrastructure. In some examples, operation 706 can be implemented in a similar manner as operation 406 of FIG. 4.

In some examples, the identifying of the information about the computer infrastructure based on the identification of the computer infrastructure comprises querying a data store, an analytic model, or a root cause analysis engine.

After operation 706, process flow 700 moves to operation 708.

Operation 708 depicts converting text of the user input data into a first numerical vector. In some examples, operation 708 can be implemented in a similar manner as operation 408 of FIG. 4.

After operation 708, process flow 700 moves to operation 710.

Operation 710 depicts creating a context of the user input data based on identifying a match between the first numerical vector and a second numerical vector, wherein the context corresponds to a natural-language version of the second numerical vector. In some examples, operation 710 can be implemented in a similar manner as operation 410 of FIG. 4.

After operation 710, process flow 700 moves to operation 712.

Operation 712 depicts combining the context and the information about the computer infrastructure into a combined context. In some examples, operation 712 can be implemented in a similar manner as operation 412 of FIG. 4.

After operation 712, process flow 700 moves to operation 714.

Operation 714 depicts sending the combined context and the user input data to a large language model to produce a result. In some examples, operation 714 can be implemented in a similar manner as operation 414 of FIG. 4.

After operation 714, process flow 700 moves to operation 716.

Operation 716 depicts making the result accessible to the user account. In some examples, operation 716 can be implemented in a similar manner as operation 416 of FIG. 4.

After operation 716, process flow 700 moves to 718, where process flow 700 ends.

FIG. 8 illustrates an example process flow 800 for using generative AI to create customized responses based on user contextual data and analytics, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 400 of FIG. 4, process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

In some examples, process flow 800 can be implemented to facilitate querying the data store, the analytic model, or the root cause analysis in operation 706 of FIG. 7.

Operation 804 depicts querying a component for information about the computer infrastructure based on the identification of the computer infrastructure. This component can be similar to product information retrieval microservice 320 of FIG. 3.

After operation 804, process flow 800 moves to operation 806.

Operation 806 depicts the component querying the data store, the analytic model, or the root cause analysis engine. That is, rather than querying these sources directly, product information retrieval microservice 320 can be accessed, and then product information retrieval microservice 320 can query the sources.

In some examples, a result of the querying comprises text that is configured to form a basis for a query derived from configuration data, alert data, or service disruption data. In some examples the result is a first result, and a second result of the querying comprises a human-readable text string of the configuration data, metrics data, the alert data, or the service disruption data. That is, in some examples, information can be returned in two forms: (a) JSON strings from config, metrics, alerts, and service disruption data; and (b) a personalized user query, which can comprise a question-like text, or other text that can form the basis for a query derived from config, alert and service disruption data.

After operation 806, process flow 800 moves to 808, where process flow 800 ends.

FIG. 9 illustrates an example process flow 900 for using generative AI to create customized responses based on user contextual data and analytics, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts receiving data that comprises an identification of a computer infrastructure that is associated with a user account. In some examples, operation 904 can be implemented in a similar manner as operation 404 of FIG. 4. After operation 904, process flow 900 moves to operation 906.

Operation 906 depicts identifying information about the computer infrastructure. In some examples, operation 906 can be implemented in a similar manner as operation 406 of FIG. 4.

In some examples, the information about the computer infrastructure comprises information about an instance of the computer infrastructure that is accessible by the user account. That is, the computer infrastructure can be infrastructure that is owned, controlled, or otherwise accessed by the user account, as opposed to general infrastructure that the user account does not have a relation to.

In some examples, the information about the computer infrastructure comprises metrics or configuration data. In some examples, the metrics or the configuration data are stored in a first data store, and wherein the information about the computer infrastructure comprises alerts stored in a second data store. In some examples, the information about the computer infrastructure comprises a health score, performance anomaly detection information, noisy neighbor information, or resources in contention information.

After operation 906, process flow 900 moves to operation 908.

Operation 908 depicts converting text of the data into a first numerical vector. In some examples, operation 908 can be implemented in a similar manner as operation 408 of FIG. 4.

After operation 908, process flow 900 moves to operation 910.

Operation 910 depicts creating a context of the data based on identifying a similarity between the first numerical vector and a second numerical vector. In some examples, operation 910 can be implemented in a similar manner as operation 410 of FIG. 4. After operation 910, process flow 900 moves to operation 912.

Operation 912 depicts combining the context and the information about the computer infrastructure into a combined context. In some examples, operation 912 can be implemented in a similar manner as operation 412 of FIG. 4. After operation 912, process flow 900 moves to operation 914.

Operation 914 depicts sending the combined context and the data to an artificial intelligence or machine learning model to produce a result. In some examples, operation 914 can be implemented in a similar manner as operation 414 of FIG. 4.

After operation 914, process flow 900 moves to operation 916.

Operation 916 depicts enabling the result to be accessed via the user account. In some examples, operation 916 can be implemented in a similar manner as operation 416 of FIG. 4.

After operation 916, process flow 900 moves to 918, where process flow 900 ends.

FIG. 10 illustrates an example process flow 1000 for using generative AI to create customized responses based on user contextual data and analytics, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

In some examples, process flow 1000 is implemented in conjunction with process flow 900 of FIG. 9. In such examples, it can be that the data is first user input data, and the first user input data indicates a first question.

Operation 1004 depicts, after enabling the result accessed via the user account, receiving second user input data that indicates a second question. That is, the user account can ask a follow-up question to the first question.

After operation 1004, process flow 1000 moves to operation 1006.

Operation 1006 depicts producing an answer to the second question based on the second question and the information about the computer infrastructure. That is, information already determined with respect to the first question can be used to answer the second question.

After operation 1006, process flow 1000 moves to 1008, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of server 102 and/or client computer 106 of FIG. 1.

In some examples, computing environment 1100 can implement one or more embodiments of the process flows of FIGS. 4-10 to use generative AI to create customized responses based on user contextual data and analytics.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the. NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving user input data that comprises an identification of a computer infrastructure component of a group of computer infrastructure components that are associated with a user account;
identifying information about the group of computer infrastructure components based on the identification of the computer infrastructure component;
converting text of the user input data into a first numerical vector;
creating a context of the user input data based on identifying a match between the first numerical vector and a second numerical vector of a group of numerical vectors, wherein the context corresponds to a natural-language version of the second numerical vector;
combining the context and the information about the group of computer infrastructure components into a combined context;
inputting the combined context and the user input data to a large language model to produce a result; and
making the result accessible via the user account.

2. The system of claim 1, wherein the result comprises information about a status of the computer infrastructure component, and a recommendation or information relevant to remediation of an issue with the computer infrastructure component or continued healthy operation of the computer infrastructure component.

3. The system of claim 1, wherein the result comprises a link to a knowledge base article regarding the computer infrastructure component.

4. The system of claim 1, wherein the operations further comprise:
converting the information about the group of computer infrastructure components from a first format to a second format before combining the context and the information about the group of computer infrastructure components.

5. The system of claim 4, wherein the second format comprises a human-readable text format.

6. The system of claim 1, wherein the converting of the text of the user input data into the first numerical vector comprises:
converting the information about the group of computer infrastructure components into the first numerical vector.

7. The system of claim 6, wherein the converting of the information about the group of computer infrastructure components into the first numerical vector comprises:
generating formulated queries based on the information about the group of computer infrastructure components, and converting the formulated queries into the first numerical vector.

8. The system of claim 7, wherein the formulated queries comprise user account-specific configuration data of the user account, an alert associated with the user account, or information about a service disruption event of the user account.

9. A method, comprising:
receiving, by a system comprising at least one processor, user input data that comprises an identification of computer infrastructure that is associated with a user account;
identifying, by the system, information about the computer infrastructure based on the identification of the computer infrastructure;
converting, by the system, text of the user input data into a first numerical vector;
creating, by the system, a context of the user input data based on identifying a match between the first numerical vector and a second numerical vector, wherein the context corresponds to a natural-language version of the second numerical vector;
combining, by the system, the context and the information about the computer infrastructure into a combined context;
sending, by the system, the combined context and the user input data to a large language model to produce a result; and
making, by the system, the result accessible to the user account.

10. The method of claim 9, wherein the identification of the computer infrastructure comprises a service tag of the computer infrastructure.

11. The method of claim 9, wherein the identifying of the information about the computer infrastructure based on the identification of the computer infrastructure comprises:
querying, by the system, a data store, an analytic model, or a root cause analysis engine.

12. The method of claim 11, wherein querying the data store, the analytic model, or the root cause analysis engine comprises:
querying a component, wherein the component is configured to query the data store, the analytic model, or the root cause analysis engine.

13. The method of claim 11, wherein a result of the querying comprises text that is configured to form a basis for a query derived from configuration data, alert data, or service disruption data.

14. The method of claim 13, wherein the result is a first result, and wherein a second result of the querying comprises a human-readable text string of the configuration data, metrics data, the alert data, or the service disruption data.

15. A non-transitory computer-readable medium comprising instructions that, in response to execution, cause a system comprising at least one processor to perform operations, comprising:
receiving data that comprises an identification of a computer infrastructure that is associated with a user account;
identifying information about the computer infrastructure;
converting text of the data into a first numerical vector;
creating a context of the data based on identifying a similarity between the first numerical vector and a second numerical vector;
combining the context and the information about the computer infrastructure into a combined context;
sending the combined context and the data to an artificial intelligence or machine learning model to produce a result; and
enabling the result to be accessed via the user account.

16. The non-transitory computer-readable medium of claim 15, wherein the data is first user input data, wherein the first user input data indicates a first question, and wherein the operations further comprise:
after enabling the result accessed via the user account, receiving second user input data that indicates a second question; and
producing an answer to the second question based on the second question and the information about the computer infrastructure.

17. The non-transitory computer-readable medium of claim 15, wherein the information about the computer infrastructure comprises information about an instance of the computer infrastructure that is accessible by the user account.

18. The non-transitory computer-readable medium of claim 15, wherein the information about the computer infrastructure comprises metrics or configuration data.

19. The non-transitory computer-readable medium of claim 18, wherein the metrics or the configuration data are stored in a first data store, and wherein the information about the computer infrastructure comprises alerts stored in a second data store.

20. The non-transitory computer-readable medium of claim 15, wherein the information about the computer infrastructure comprises a health score, performance anomaly detection information, noisy neighbor information, or resources in contention information.
